(19) United States
(12) Patent Application Publication
(10) Pub. No.: US 2024/0086206 A1
(43) Pub. Date: Mar. 14, 2024

(54) SYSTEM AND METHODS THAT FACILITATE ADD-ON FUNCTIONS WITH INDUSTRIAL DEVICES

(71) Applicant: ROCKWELL AUTOMATION TECHNOLOGIES, INC., MAYFIELD HEIGHTS, OH (US)

(72) Inventors: Michael J. Viste, Grafton, WI (US); ZaiQiang Leng, Singapore (SG); Justin A. Wengatz, North Ridgeville, OH (US)

(21) Appl. No.: 18/511,554

(22) Filed: Nov. 16, 2023

Related U.S. Application Data
(63) Continuation-in-part of application No. 17/897,024, filed on Aug. 26, 2022.

(51) Int. Cl. G06F 9/445; G05B 15/02

(52) U.S. Cl. CPC G06F 9/44526; G05B 15/02

(57) ABSTRACT

Systems and methods for facilitating add-on functions for employment with an industrial device. One system includes an electronic processor configured to receive, via a user interface, a user input defining an add-on function. The electronic processor may be configured to compile an object file for the add-on function. The electronic processor may be configured to control access to the object file for executing the add-on function. The electronic processor may be configured to receive a request for the object file. The electronic processor may be configured to transmit the object file for executing the add-on function.

### CROSS-REFERENCES TO RELATED APPLICATIONS

This application is a continuation-in-part of and claims priority to U.S. application Ser. No. 17/897,024 entitled “SYSTEMS AND METHODS THAT FACILITATE ADD-ON FUNCTIONS FOR EMPLOYMENT WITHIN AN INDUSTRIAL DEVICE,” filed Aug. 26, 2022, which is incorporated herein by reference in its entirety.

### BACKGROUND INFORMATION

Industrial controllers are specialized computer systems used for the control of industrial processes or machinery, for example, in a factory environment. Generally, an industrial controller executes a stored control program that reads inputs from a variety of sensors associated with the controlled process and machine and, sensing the conditions of the process or machine and based on those inputs and a stored control program, calculates a set of outputs used to control actuators controlling the process or machine.

Industrial controllers differ from conventional computers in a number of ways. Physically, industrial controllers are constructed to be substantially more robust against shock and damage and to better resist external contaminants and extreme environmental conditions than conventional computers. The processors and operating systems are optimized for real-time control and are programmed with languages designed to permit rapid development of control programs tailored to a constantly varying set of machine control or process control applications.

### SUMMARY

The following presents a simplified summary of the disclosed technology herein in order to provide a basic understanding of some aspects of the disclosed technology. This summary is not an extensive overview of the disclosed technology. It is intended neither to identify key or critical elements of the disclosed technology nor to delineate the scope of the disclosed technology. Its sole purpose is to present some concepts of the disclosed technology in a simplified form as a prelude to the more detailed description that is presented later.

Industrial controllers are special purpose processing devices used for controlling (e.g., automated and semi-automated) industrial processes, machines, manufacturing equipment, plants, and the like. A typical controller executes a control program or routine in order to measure one or more process variables or inputs representative of the status of a controlled process and/or effectuate outputs associated with control of the process. Such inputs and outputs can be binary, (e.g., “1” or “0,” “on” or “off,” etc.), and/or analog, assuming a continuous range of values. A typical control routine can be created in a controller configuration environment that has various tools and interfaces whereby a developer can construct and implement a control strategy using industrial and conventional programming languages or graphical representations of control functionality. Such a control routine can be downloaded from the configuration system into one or more controllers for implementation of the control strategy in controlling a process or machine.

Measured inputs received from a controlled process and outputs transmitted to the process can pass through one or more input/output (“I/O”) modules in a control system. Such modules can serve in the capacity of an electrical interface between the controller and the controlled process and can be located local or remote from the controller. Inputs and outputs can be recorded in an I/O memory. The input values can be asynchronously or synchronously read from the controlled process by one or more input modules and output values can be written directly to memory by a processor for subsequent communication to the process by specialized communications circuitry. An output module can interface directly with a controlled process by providing an output from memory to an actuator such as a motor, drive, valve, solenoid, and the like.

During execution of the control routine, values of the inputs and outputs exchanged with the controlled process can pass through memory. The values of inputs in memory can be asynchronously or synchronously updated from the controlled process by dedicated and/or common scanning circuitry. Such scanning circuitry can communicate with input and/or output modules over a bus on a backplane or network. The scanning circuitry can also asynchronously or synchronously write values of the outputs in memory to the controlled process. The output values from the memory can be communicated to one or more output modules for interfacing with the process. Thus, a controller processor can simply access the memory rather than needing to communicate directly with the controlled process.

In distributed control systems, controller hardware configuration can be facilitated by separating the industrial controller into a number of control elements, each of which performs a different function. Particular control modules needed for the control task can then be connected together on a common backplane within a rack and/or through a network or other communications medium. The control modules can include processors, power supplies, network communication modules, and I/O modules exchanging input and output signals directly with the controlled process. Data can be exchanged between modules using a backplane communications bus, which can be serial or parallel, or via a network. In addition to performing I/O operations based solely on network communications, smart modules can execute autonomous logical or other control programs or routines. Various control modules of a distributed industrial control system can be spatially distributed along a common communication link in several locations. Certain I/O modules can thus be located proximate a portion of the controlled equipment, and away from the controller. Data can be communicated with these remote modules over a common communication link, or network, wherein all modules on the network communicate via a standard communications protocol.

In a typical distributed control system, one or more I/O modules are provided for interfacing with a process. The outputs derive their control or output values in the form of a message from a master or peer device over a network or a backplane. For example, an output module can receive an output value from a processor via a communications network or a backplane communications bus. The desired output value is generally sent to the output module in a message. The output module receiving such a message may provide a corresponding output (analog or digital) to the controlled process. Input modules measure a value of a process variable and report the input values to another device over a network or backplane. The input values can be used by a processor for performing control computations.

As noted above, a controller can execute routines to control machines, processes, manufacturing equipment, plants, and the like, and such routines can be created in a controller configuration environment and downloaded to the controller for execution. In many instances, an end-user tailors code for a particular controller in order to control a specific machine, process, equipment, plant, etc. in a desired manner. Add-on instructions is one example of a conventional approach for tailoring code for a particular controller. For example, within this code, the end-user can make one or more calls to one or more add-on instructions. Such add-on instructions, in general, respectively include and relate a set of re-usable routines, data parameters, and/or state data. However, such add-on instructions, in general, do not enable an end-user to integrate with open system libraries, such as, e.g., libraries written in C/C++ using the GNU compiler collection (“GCC”). These libraries can contain generally useful functions, such as in a runtime library from a toolchain vendor or application specific functions from an application associated with the industrial controller. As one example, where the industrial device is a Logix5000 Controller from Rockwell Automation, Inc. of Milwaukee, Wis., an end-user of the Logix5000 Controller cannot integrate with an open system library from a Logix application associated with the Logix5000 Controller. Additionally, while some approaches enable an end-user to tailor code for a particular controller, the process of implementing such conventional approaches is generally an extensive and disruptive process. This inability to integrate with open systems and the extensive implementation process are significant shortcomings with conventional systems.

The subject matter disclosed within relates generally to industrial control systems and, more particularly, to systems and methods that create and manage add-on functions that are called by programs executing within industrial devices. In particular, the subject matter disclosed herein provides systems and methods that facilitate re-use of logic encapsulated in an add-on function(s) that are called by a program(s) executing within an industrial device. Such add-on functions can be generated through a controller configuration environment to include and relate a function name, one or more parameters, and/or a return type and can be protected by various known security techniques to mitigate unauthorized access. A user may define source logic for the add-on function to execute or the source logic can be used to link to a function with the same signature in a library that exists in the controller.

One configuration may include a system for facilitating add-on functions for industrial devices. The system may include one or more electronic processors. The one or more electronic processors may be configured to receive, via a user interface, a user input defining an add-on function, wherein the user input includes a function name for the add-on function. The one or more electronic processors may be configured to compile, based on the user input, an object file for the add-on function. The one or more electronic processors may be configured to control access to the object file for executing the add-on function. The one or more electronic processors may be configured to receive, from an industrial device of an industrial system, a request for the object file. The one or more electronic processors may be configured to transmit, to the industrial device of the industrial system, the object file for executing the add-on function.

Another configuration may include a method for facilitating add-on functions for industrial devices. The method may include receiving, with one or more electronic processors, user input defining a plurality of add-on functions, wherein the user input includes, for each add-on function of the plurality of add-on functions, at least one of a function name, a parameter, or a return type. The method may include compiling, with the one or more electronic processors, an object file for each add-on function of the plurality of add-on functions as a set of object files. The method may include storing, with the one or more electronic processors, the set of object files in one or more function libraries. The method may include receiving, with the one or more electronic processors, from a first industrial device, a request for a first object file included in the set of object files, wherein the first object file includes object code for performing a first add-on function of the plurality of add-on functions. The method may include transmitting, with the one or more electronic processors, to the first industrial device, the first object file including object code that, when executed, performs the first add-on function.

The foregoing and other aspects and advantages of the present disclosure will appear from the following description. In the description, reference is made to the accompanying drawings which form a part hereof, and in which there is shown by way of illustrations one or more embodiments of the present disclosure. Such embodiments do not necessarily represent the full scope of the present disclosure, however, and reference is made therefore to the claims and herein for interpreting the scope of the present disclosure.

### BRIEF DESCRIPTION OF DRAWINGS

The present disclosure will be better understood and features, aspects and advantages other than those set forth above will become apparent when consideration is given to the following detailed description thereof. Such detailed description makes reference to the following drawings.

FIG. 1 schematically illustrates an example object creation per instance of an add-on instruction in accordance with some embodiments.

FIG. 2 illustrates the add-on instruction of FIG. 1 having a single-entry point function according to some embodiments.

FIG. 3 schematically illustrates a system for facilitating add-on functions according to some embodiments.

FIG. 4 schematically illustrates a user device included in the system of FIG. 3 according to some embodiments.

FIG. 5 schematically illustrates an industrial device included in the system of FIG. 3 according to some embodiments.

FIG. 6 an example diagram of facilitating generation of an add-on function according to some embodiments.

FIG. 7 is a flowchart illustrating a method for facilitating add-on functions using the system of FIG. 3 according to some embodiments.

FIG. 8 illustrates an example implementation of an add-on function according to some embodiments.

FIG. 9 is a table describing the add-on function of FIG. 8 according to some embodiments.

FIG. 10 is a flowchart illustrating an example method for generating add-on functions for implementation with an industrial device according to some embodiments.

### DETAILED DESCRIPTION

As utilized herein, terms “component,” “system,” “controller,” “device,” “manager,” and variants thereof are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers.

The disclosed technology is described with reference to the drawings, wherein like reference numerals are used to refer to like elements throughout. In the following description, for purposes of explanation, numerous specific details are set forth in order to provide a thorough understanding of the disclosed technology. It may be evident, however, that the disclosed technology may be practiced without these specific details. In other instances, well-known structures and devices are shown in block diagram form in order to facilitate describing the disclosed technology.

Disclosed herein are systems and methods for creating and managing add-on functions, such as, e.g., user defined functions configured to (a) execute logic and/or (b) call a function in an available library. Accordingly, the subject matter disclosed herein generally relate to creating and managing add-on functions that are called by user programs executing within industrial devices. In particular, the subject matter disclosed herein provides systems and methods that facilitate re-use of logic encapsulated in an add-on function(s) that are called by a user program(s) executing within an industrial device. Such add-on functions can be generated through a controller configuration environment to include and relate a function name, one or more parameters, and/or a return type and can be protected by various known security techniques to mitigate unauthorized access. A user may define source logic for the add-on function to execute or may link to a function with the same signature in a library that exists in the controller.

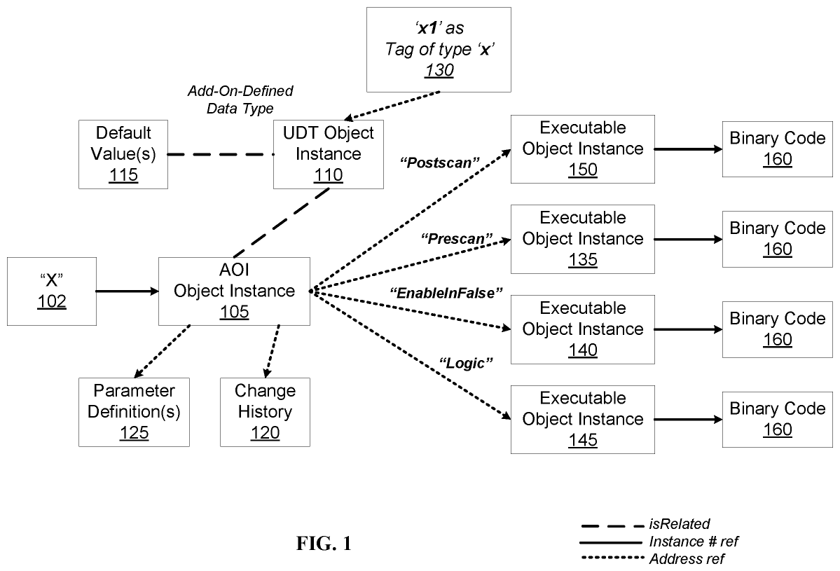

As noted above, the extensive implementation process can be a significant shortcoming of some systems. For example, FIG. 1 schematically illustrates an example common industrial protocol (“CIP”) (supported by Open DeviceNet Vendors Association (“ODVA”)) object creation per instance of an add-on instruction (“AOI”) in accordance with some embodiments. In the example illustrated in FIG. 1, “X” (represented in FIG. 1 by reference numeral 102) is the name of the Add-On Instruction (definition) illustrated as “AOI object instance” (represented in FIG. 1 by reference numeral 105). Each AOI has an Add-On-Defined data type; also named “X” in this example (e.g., a “UDT object instance” represented by reference numeral 110 in FIG. 1). Each of these Add-On-Defined data types can specify its “Default Values” (represented in FIG. 1 by reference numeral 115). Each AOI also has Data Table objects for “Change History” and “Parameter Definitions” (represented in FIG. 1 by reference numerals 120 and 125, respectively).

In the example of FIG. 1, “x1” is an AOI backing tag used for this invocation of X (represented in FIG. 1 by reference numeral 130). Every tag has a symbol and data table instance created for it and the AOI backing tag is no different. Data table instances are created based on the User Defined Template specified during its creation and immediately initialized with the default values provided it.

Each AOI (definition) has one or more executable object instances (e.g., one or more routines of the user program) assigned to it to be invoked during each of the four possible execution modes, as illustrated in FIG. 1. The execution modes include a “Prescan” mode, an “EnableInFalse” mode, a “Logic” mode (e.g., an “EnableInTrue” mode), and a “Postscan” mode (represented in FIG. 1 by reference numerals 135, 140, 145, and 150, respectively). Each executable object instance has one or more files that hold the binary code (represented in FIG. 1 by reference numeral 160) to be executed when the routine of the user program is invoked by its containing AOI. The source for each routine of the user program can be stored in a file system rather than memory.

Accordingly, as illustrated in FIG. 1, there are a significant number of objects needing instantiation in the controller to invoke a single AOI, which results, at least in part, in a complex and extensive implementation process.

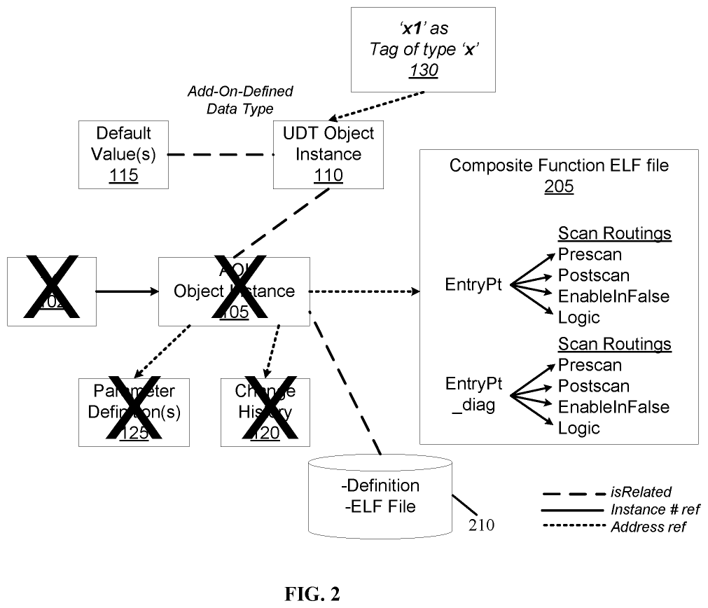

FIG. 2 illustrates the same AOI as in FIG. 1 except, in FIG. 2, the AOI has a single-entry point function (represented in FIG. 2 by reference numeral 205) that replaces the source logic contained in the four executable objects (e.g., reference numerals 135, 140, 145, and 150 of FIG. 1). This source-to-source translation is often called transpiling. This simpler approach uses less memory and executes faster. Safety AOI's may use another entry point function for diagnostic behavior. As illustrated in FIG. 2, the entry point function is compiled into an executable and linkable format (“ELF”) file. A user may download ELF file individually, include the ELF file as part of a library (represented in FIG. 2 by reference numeral 210), or a combination thereof. When the corresponding binaries (e.g., the ELF file(s)) are downloaded before they are referenced, the linking operation will be successful. Since the function is called from user code, the AOI object instance and its collateral are no longer needed. Such implementations may be referred to as composite instructions.

Despite the improvements provided by composite instructions, there are still a number of shortcomings involved with some methods of tailoring code for a controller (e.g., an industrial device). For instance, some methods generally cannot call subroutines. As one example, AOIs may be limited to calling other AOIs. Some methods also may generally involve a significant level of programming and support to create and employ, including, e.g., (a) specifying Input, Output, InOut, and local parameters, (b) source logic is programmed across different routines of the user program (e.g., up to four routines, one per scan mode), (c) initialization/default values, configuration data, some optional features, (d) backing tag creation with specific invocation usage, and (e) invocation stack with overflow protection and stack trace handling for faults, and the like. While some methods, such as with AOIs, align with user defined function blocks (e.g., IEC 61131-3 Table 40), add-on functions (“AOFs”) may increase compliance by offering an end-user defined functions (e.g., IEC 61131-3 Table 19). Additionally, AOFs may be (a) easier for end-users to define and invoke, (b) take less memory (e.g., fewer objects), and (c) execute faster (e.g., less indirection) than AOIs designed for the same purpose. AOFs do not retain state and can more easily be reused without initialization and persistence concerns. In some instances, an AOF may return a result. In other instances, an AOF may not return a result. Further, AOFs can be configured to (a) invoke functions developed outside of a device-specific application (e.g., an application associated with a specific industrial controller) (e.g., external AOFs) or (b) execute source logic as programmed locally.

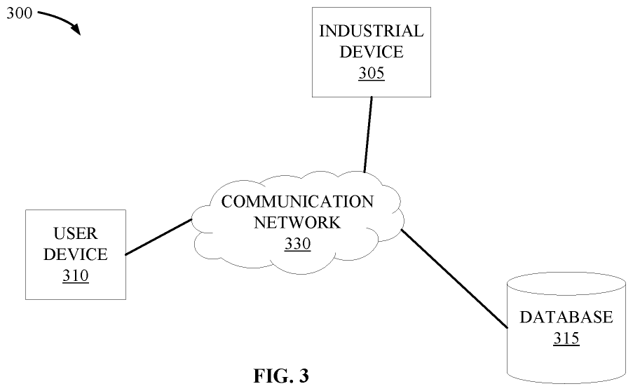

FIG. 3 schematically illustrates a system 300 for facilitating AOFs according to some embodiments. In the illustrated example, the system 300 includes an industrial device 305, a user device 310, and a database 315. In some embodiments, the system 300 includes fewer, additional, or different components in different configurations than illustrated in FIG. 3. As one example, the system 300 may include multiple industrial devices 305, multiple user devices 310, multiple databases 315, or a combination thereof. As another example, one or more components of the system 300 may be combined into a single device, such as, e.g., the user device 310 and the database 315.

The industrial device 305, the user device 310, and the database 315 communicate over one or more wired or wireless communication networks 330. Portions of the communication networks 330 may be implemented using a wide area network, such as the Internet, a local area network, such as a BLUETOOTH® or WI-FIE), and combinations or derivatives thereof. Alternatively, or in addition, in some embodiments, components of the system 300 communicate directly as compared to through the communication network 330. Also, in some embodiments, the components of the system 300 can communicate through one or more intermediary devices not illustrated in FIG. 3.

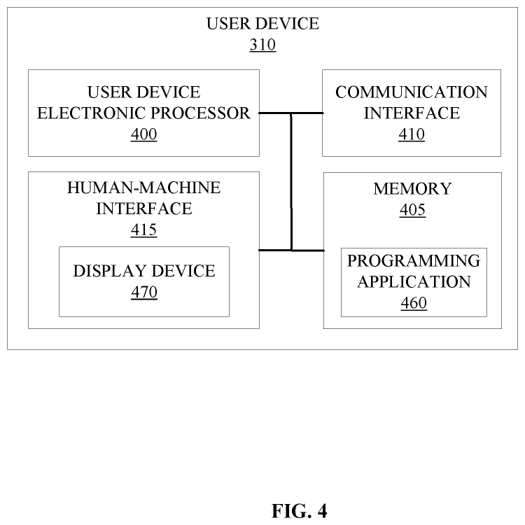

The user device 310 may be a computing device, such as a desktop computer, a laptop computer, a tablet computer, a terminal, a smart telephone, a smart television, a smart wearable, or another suitable computing device that interfaces with a user. As illustrated in FIG. 4, the user device 310 includes a user device electronic processor 400, a user device memory 405, a user device communication interface 410, and a human-machine interface (“HMI”) 415. The user device electronic processor 400, the user device memory 405, the user device communication interface 410, and the HMI 415 communicate wirelessly, over one or more communication lines or buses, or a combination thereof. The user device 310 may include additional components than those illustrated in FIG. 4 in various configurations. The user device 310 may also perform additional functionality other than the functionality described herein. Also, the functionality described herein as being performed by the user device 310 may be distributed among multiple devices (e.g., as part of a cloud service or cloud-computing environment), combined with another component of the system 300 (e.g., combined with the database 315, another component of the system 300, or the like), or a combination thereof.

The user device communication interface 410 may include a transceiver that communicates with the industrial device 305, the database 315, or a combination thereof over the communication network 330 and, optionally, one or more other communication networks or connections. In some embodiments, the user device communication interface 410 enables the user device 310 to communicate with the industrial device 305, the database 315, or a combination thereof over one or more wired or wireless connections. The user device electronic processor 400 includes a microprocessor, an application-specific integrated circuit (“ASIC”), or another suitable electronic device for processing data, and the user device memory 405 includes a non-transitory, computer-readable storage medium. The user device electronic processor 400 is configured to retrieve instructions and data from the user device memory 405 and execute the instructions.

As one example, as illustrated in FIG. 4, the user device memory 405 includes a programing application 460 (referred to herein as “the application 460”). The application 460 is a software application executable by the user device electronic processor 400 in the example illustrated and as specifically discussed below, although a similarly purposed module can be implemented in other ways in other examples. The user device electronic processor 400 executes the application 460 to facilitate user programming for industrial devices, and more specifically, to facilitate the generation and implementation of an AOF for employment with a user program for execution on an industrial device (e.g., the industrial device 305).

As noted above, in some embodiments, the functionality (or a portion thereof) described herein as being performed by the user device 310 may be distributed among multiple devices (e.g., as part of a cloud service or cloud-computing environment). As one example, in some embodiments, the system 300 includes a server (e.g., a computing device). The server may include similar components as the user device 310, such as an electronic processor (e.g., a microprocessor, an ASIC, or another suitable electronic device), a memory (e.g., a non-transitory, computer-readable storage medium), a communication interface, such as a transceiver, for communicating over the communication network 330 and, optionally, one or more additional communication networks or connections. Accordingly, in some embodiments, the server may store the application 460 as part of providing a programming service through the server. In such embodiments, to communicate with the server (e.g., interact with the application 460), the user device 310 may store a browser application or a dedicated software application executable by the user device electronic processor 400.

As described in greater detail herein, the application 460 may facilitate generation of an AOF (e.g., a custom or user-defined AOF), implementation (or invocation) of an AOF (e.g., a standard AOF, a custom or user-defined AOF, or a combination thereof), or a combination thereof. As one example, a user may interact with the application 460 to generate an AOF (e.g., a list of functions), where that AOF may be invoked by a routine of a user program of an industrial device (e.g., the industrial controller 305). Alternatively, or in addition, a user may interact with the application 460 to generate a routine or subroutine of a user program. In some instances, a user may generate a routine that invokes an AOF (e.g., as part of executing the routine of the user program. Accordingly, the AOF may be invoked by one or more user programs (or routine(s) thereof). In some instances, a first user may generate and store an AOF and a second user may access (or invoke) the AOF for implementation in a user program of the second user. Accordingly, in some instances, a user that did not author (or otherwise generate) the AOF may access and invoke the AOF. Alternatively, or in addition, a user may interact with the application 460 to implement (or invoke) an AOF authored (or otherwise generated) by that user in a user program of that user. As one example, a first user may code a routine for use in a user program, where the routine calls an AOF, where that AOF may be authored or otherwise generated by the first user or another different user.

As noted above, the user device 310 may also include the HMI 415 for interacting with a user. The HMI 415 may include one or more input devices, one or more output devices, or a combination thereof. Accordingly, in some configurations, the HMI 415 allows a user to interact with (e.g., provide input to and receive output from) the user device 310. For example, the HMI 415 may include a keyboard, a cursor-control device (e.g., a mouse), a touch screen, a scroll ball, a mechanical button, a display device (e.g., a liquid crystal display (“LCD”)), a printer, a speaker, a microphone, or a combination thereof. As illustrated in FIG. 4, in some embodiments, the HMI 415 includes a display device 470. The display device 470 may be included in the same housing as the user device 310 or may communicate with the user device 310 over one or more wired or wireless connections. For example, in some configurations, the display device 415 is a touchscreen included in a laptop computer or a tablet computer. In other configurations, the display device 415 is a monitor, a television, or a projector coupled to a terminal, desktop computer, or the like via one or more cables.

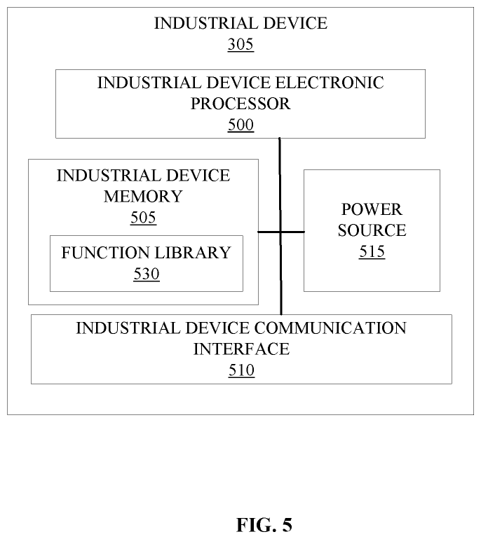

FIG. 5 illustrates an example industrial device (e.g., the industrial device 305) in accordance with some embodiments. The industrial device 305 can be an industrial controller, a programmable logic controller (“PLC”), and the like. In the illustrated example, the industrial device 305 includes an industrial device electronic processor 500, an industrial device memory 505, an industrial device communication interface 510, and a power source 515. The industrial device electronic processor 500, the industrial device memory 505, the industrial device communication interface 510, and the power source 515 communicate over one or more communication lines or buses. The industrial device 305 may include additional components than those illustrated in FIG. 5 in various configurations. The industrial device 305 may also perform additional functionality other than the functionality described herein.

In some embodiments, the industrial device communication interface 510 enables the industrial device 305 to communicate with the user device 305, the database 315, or a combination thereof over one or more wired or wireless connections. The industrial device electronic processor 500 includes a microprocessor, an ASIC, or another suitable electronic device for processing data, and the industrial device memory 505 includes a non-transitory, computer-readable storage medium. The industrial device electronic processor 500 is configured to retrieve instructions and data from the industrial device memory 505 and execute the instructions.

As described in greater detail herein, in some embodiments, the industrial device electronic processor 500 executes user programs and associated AOFs, which may be stored within a function library 530 of the industrial device memory 505. Alternatively, or in addition, the function library 530 may be stored external to the industrial device 305 (as described in greater detail herein with respect to the database 315). The industrial device communication interface 510 enables communication. As one example, the industrial device communication interface 510 may include an input channel that can be employed to receive analog and digital signals through sensors, switches, and the like to provide information indicative of state and/or relating to a process, and an output channel that can be utilized to convey a next state to an entity under the control of the controller (e.g., an industrial control system).

Returning to FIG. 3, the system 300 may also include the database 315. The database 315 may store one or more function libraries (e.g., the function library 530). A function library may include a set of functions (e.g., AOFs), including, e.g., a set of operations or source logic for executing (or otherwise performing) an associated function. As one example, a function may be a subroutine that performs a set of operations or instructions. In some embodiments, a function library may be associated with a standard programming language. In such embodiments, the set of functions included in the function library may be a set of standard functions of the corresponding programming language. Standard functions may comprise of code associated with functions contained in a predetermined library of an embedded system. As one example, when the function library 530 is associated with a C/C++ programming language, the function library 530 may include a set of standard C/C++ functions. Accordingly, in some embodiments, a function library includes a set of pre-existing standard functions (e.g., as a list of pre-existing standard functions). In some examples, the function library 530 may be implemented with (or associated with) an open system. According to such examples, the function library 530 may include one or more AOFs created by a third-party user, where such AOFs may adhere to a programming standard. Such instances may support or facilitate open system AOF call(s) to AOF(s) created by others where this AOF(s) adhere to a programming standard.

Alternatively, or in addition, in some embodiments, a set of functions stored in the function library may be a set of custom (or user-defined) functions. As one example, a user may (via the application 460) generate a set of custom AOFs, which are not contained within the standard functions of a predetermined library, and store the set of custom AOFs as a custom function library, such that the custom function library may be implemented by a user program that utilizes at least one custom AOF. As described in greater detail herein, a user may access and download a corresponding function library (e.g., from the database 315) as part of generating or implementing an AOF, such that a corresponding function library is provided to (e.g., downloaded to) the industrial device 305 with an AOF (or a routine associated with the AOF). Accordingly, in some configurations, an AOF (including, e.g., a user defined or custom AOF) may be compiled and installed within a library (e.g., the function library 530), where that library may be saved and downloaded with an application that utilizes the AOF.

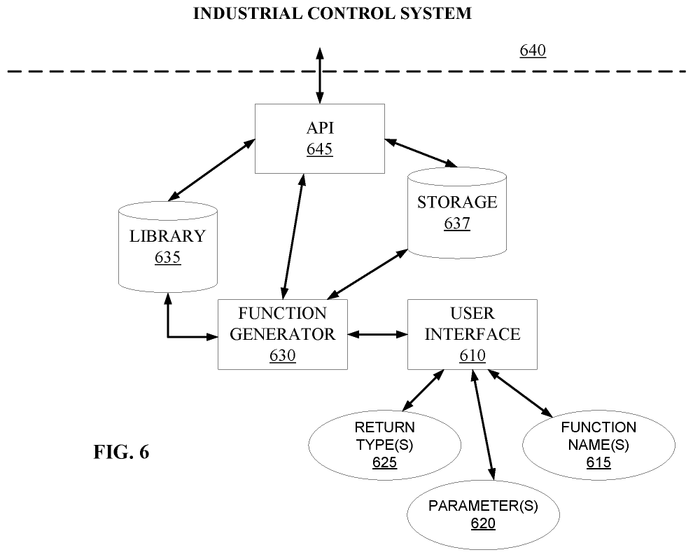

FIG. 6 illustrates an example diagram 600 of facilitating generation of an AOF and/or other user programs according to some embodiments. In the illustrated example, the diagram 600 includes a user interface 610 that may be generated and provided to a user. In some embodiments, the user device electronic processor 400 executing the application 460 may generate and provide the user interface 610. The user interface 610 may be (or included as part of), e.g., a graphical user interface (“GUI”), a command line interface, an Application Programming Interface (“API”), an industrial control system environment, or the like. In some embodiments, the user interface 610 is provided to a user via the HMI 415 (e.g., the display device 470) of the user device 310. The user interface 610 can provide a developer with tools for creating AOFs, editing AOFs, and the like, including, e.g., associating function names 615, parameters 620, return types 625, to create a function signature that uniquely identifies the AOF. Some programming languages, such as, e.g., C++, allows multiple functions to have the same name while each of those functions may perform different functions (e.g., have difference implementations). While two or more functions may have the same name, each function may be associated with (or have) different parameters (e.g., parameters 620). As one example, in C++, a first function and a second function may have the same function name while the first function has a different signature (e.g., parameters 620) than the second function. This can be supported by the AOF tools when a compiler used for the AOF and the invocation of the AOF utilizes the same name mangling. The function name 615 may be an identifier or other indicator of an associated AOF. For example, when invoking an AOF, a call for the AOF may include the function name 615 for that AOF (e.g., such that the correct AOF is invoked responsive to the call). The parameter(s) 620 may include a set of variables to be used by or included in the execution of an AOF. For example, execution of an AOF may include performing one or more operations on or with respect to the parameter(s) 620 identified for that AOF. The return type(s) 625 may specify data types to be returned by the AOF as a result of executing that AOF. For example, the return type 625 may include a real number, a string, an integer, etc. It is to be appreciated that development can be achieved via standard industrial control languages, such as structured text (“ST”), sequential function chart (“SFC”), functional block diagram (“FBD”), and ladder diagram (“LD”), as well as other languages, such as C, C++, C#, Graphical Motion Language (“GML”), Python, Java, Flow-Charts, etc., and/or any combination thereof. In some configurations, when a programming language other than C++ is used, the utilized programming application can transpile the programming language into C++ code and, in some instances, conform to established C++ standards, calling conventions, etc. Accordingly, in some embodiments, a user may interact with the user interface 610 to generate one or more custom or user-defined functions.

In one aspect, the developer can invoke a function generator 630 (e.g., as a function or module provided by the application 640) to create a package of one or more AOFs, where AOFs and/or packages thereof can be generated in various programming languages, including industrial control languages like ST, SFC, FBD, and LD and various combinations thereof, which provides flexibility and allows a developer to select a language(s) suited to a particular task(s). In some instances, a user may utilize a programming platform or application, such as, e.g., MATLAB®, to model functional behavior. In such instances, the programming platform or application may generate C++ code (or ST code) from that modeled functional behavior. In such instances, the programming platform or application may provide C++ code associated with the modeled functional behavior to a compiler associated with the AOF(s). In addition, the foregoing provides for modularization and re-use, which can improve programming and user efficiency because the developer only needs to indicate the desired programming language or a given AOF, and the function generator 630 will supply the AOF in the desired programming language

Furthermore, in some embodiments, AOFs can be assembled as a library 635 (e.g., the function library 530). The library 635 can be created via a markup language (e.g., Extensible Markup Language (“XML”), Standard Generalized Markup Language (“SGML”), Hyper Text Markup Language (“HTML”), and the like), a binary file, an SQL database, and the like, where the controller language appears inside the language as content of a routine of the user program. It is to be appreciated that individual AOFs, a package of more than one AOF, a library of AOFs, or a combination thereof can be encrypted, encoded, password protected, and the like in order to prevent unauthorized users from accessing the functions. In one example, each AOF within a library may contain application code with encryption in order to limit IP exposure, which may ensure that the ability to decrypt the AOF is limited to the controller containing the library. In addition, in some instances, properties associated with such functions and/or libraries can be configured to provide and/or limit read, write, and execute privileges. In one example, a license or subscription may be utilized to authorize a user to access and use the contents of a function and/or library. Accordingly, in some instances, access or user permissions may be granted based on a license or subscription-based model.

Generated AOFs can be saved in a storage component 637 (e.g., the database 315, the user device memory 405, etc.), assembled as a library in library 635, and/or transferred to an industrial control system 640 (via, e.g., an API 645) (e.g., to the industrial device 305). Additionally, AOFs saved within the storage component 637 and/or saved within the library 635 can be conveyed to the industrial control system 640 via the API 645. These generated AOFs may be associated with stopping, continuing, stepping through, or resuming a step being performed by the IDE.

Alternatively, or in addition, the user interface 610 can be utilized by an end-user to generate specific user programs that call one or more AOFs (e.g., one or more AOFs stored in a function library). Such specific user programs can be generated via industrial control languages such as ST, SFC, FBD, and LD and various combinations thereof, including a language(s) similar and/or different from the language utilized by particular AOFs called by the specific user program. The end-user can develop user programs via the user interface 610 and the function generator 630, where such user programs can call AOFs in the storage component 637 and/or the library 635. In addition, such user programs can be stored within the storage component 637 and/or conveyed to the industrial device 305 for execution. For example, as noted herein, in some configurations, an AOF (including, e.g., a user defined or custom AOF) may be compiled and installed within a library (e.g., the function library 530, the library 635, or the like), where that library may be saved and downloaded with an application that utilizes the AOF.

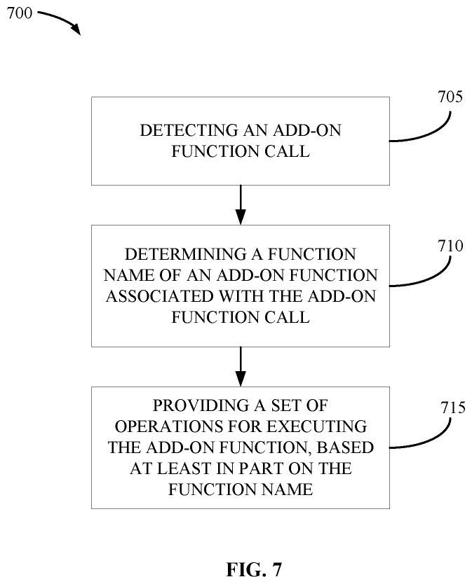

FIG. 7 is a flowchart illustrating an example method 700 for facilitating AOFs for employment with an industrial device (e.g., the industrial device 305) according to some embodiments. The method 700 is described herein as being performed by the industrial device 305 (e.g., the industrial device electronic processor 500).

As illustrated in FIG. 7, the method 700 includes detecting, with the industrial device electronic processor 500, an AOF call (at block 705). The AOF call may be from a user program executing within the industrial device 305. The industrial device electronic processor 500 may then determine a function name of an AOF associated with the AOF call (at block 710). In some embodiments, the AOF call indicates a function name of an AOF to be invoked. In response to determining the function name of the AOF to be invoked, the industrial device electronic processor 500 may then identify a set of operations for the AOF to be invoked by matching the determined function name to a function name stored in a function library (e.g., the function library 530). The function library 530 may include a set of functions, where each function is identifiable by a function name and associated with a set of operations for executing the corresponding function. Accordingly, the industrial device electronic processor 500 may identify the set of functions for executing the corresponding function by matching the determined function name (associated with the detected AOF call) to a function name stored in the function library, where the set of functions is linked to the function name stored in the function library that matches the determined function name. As illustrated in FIG. 7, the industrial device electronic processor 500 may then provide the set of operations for executing the AOF (at block 715). In some embodiments, the industrial device electronic processor 500 may provide the set of operations based at least in part on the function name of the AOF to be invoked. After providing the set of operations, the set of operations may be executed such that the AOF called by the AOF call is invoked (e.g., as part of executing the user program).

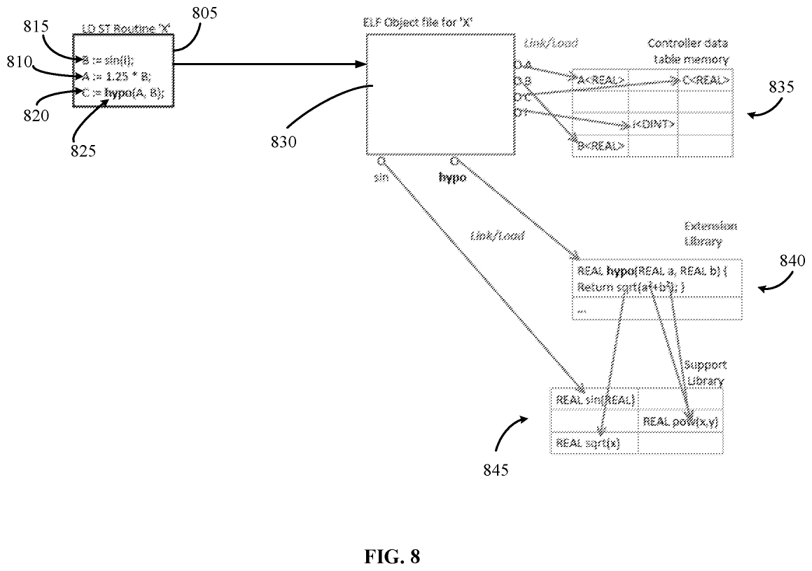

FIG. 8 illustrates an example implementation of AOFs for employment within an industrial device (e.g., the industrial device 305). As illustrated in FIG. 8, a user may provide a routine 805 (e.g., as a user program or portion thereof). The routine 805 of FIG. 8 is written in ladder and structured text programing languages. In the illustrated example, the routine 805 is called “X”.

In some embodiments, to verify the routine 805, each tag used with respect to the routine 805 is declared using predefined data types. A predefined data type may be the data type associated with any global variables stored in the AOF. Additionally, in some embodiments, each instruction is also predefined. Following the example of FIG. 8, the tags and instructions may be defined as follows:
DINT I; // transpile inserts toREAL( ) type conversion for usage with sin( . . . )
REAL A, B, C;

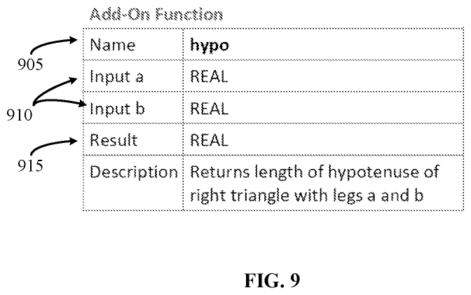

The routine 805 includes three operations: an “A” operation 810, a “B” operation 815, and a “C” operation 820. As illustrated in FIG. 8, the “C” operation 820 includes a reference to an AOF 825 (entitled “hypo” in FIG. 8). As illustrated in FIG. 9, the AOF 825 is associated with a function name 905 (e.g., “hypo” in FIG. 9), a set of parameters 910 (e.g., “Input a—REAL” and “Input b—REAL” in FIG. 9), and a result type 915 (e.g., “REAL” in FIG. 9). As illustrated in FIG. 9, the AOF 825 has a description of: “Returns length of hypotenuse of right triangles with legs a and b.” Accordingly, embodiments described herein enable AOFs to be declared as well. The AOF may reside in a library (e.g., the function library 530). Additionally, the AOFs may be declared with extern visibility (e.g., exposed as part of an exposed API, such as, e.g., the API 645 of FIG. 6, of the corresponding industrial device as opposed to being stored in a library) and follow naming rules, such as, e.g., C++ name mangling rules.

Returning to FIG. 8, after the user provides the routine 805 (e.g., via the application 460), the routine 805 may be compiled (or transpiled) into an object file 830. The object file 830 may be an ELF object file, such as, e.g., a relocatable ELF object file. After the object file 830 is generated (or compiled), the object file 830 may be provided to the industrial device 305. In some embodiments, when the object file 830 is provided to the industrial device 305, a function library, such as, e.g., the function library 530 (e.g., a function library corresponding to the add-on function) is also provided to the industrial device 305.

As illustrated in FIG. 8, contents of the object file 830 are linked and loaded within the industrial device 305. As one example, the parameters (A, B, C, and i) are linked and loaded to a controller data table memory (represented in FIG. 8 by reference numeral 835). As another example, the AOF 825 is linked and loaded with respect to an extension library (e.g., the function library 530) (represented in FIG. 8 by reference numeral 840). An extension library may comprise additional functions that are not included within a support library. As another example, the sin function is linked and loaded with respect to a support library such as, e.g., a pre-existing function library of the industrial device 305 (represented in FIG. 8 by reference numeral 845).

In some embodiments, the object file 830 may have unresolved references which may be fixed by a linker for the object file 830 to be used while executing the user program. In some embodiments, for the references to be resolved, the linker may find an exact match from the list of data table objects and external functions made available to the linker. That is, each data table object must be of the same data type as the declaration specifies. This is known as having a common type system shared by the industrial device 305 and a programing environment associated with the industrial device 305 (e.g., a Logix controller and Logix programming environment).

Accordingly, embodiments described herein provide for systems and methods of facilitating AOFs for employment within industrial devices. In particular, embodiments provide for the implementation of user defined functions configured to execute logic, call a function in an available library, or a combination thereof. As noted above, the implementation of AOFs provides significant technical improvements over prior approaches. For instance, implementation of AOFs provides both end-users and developers the ability to leverage AOFs as a preferred solution. As one example, implementation of external AOFs enables calling of any function (e.g., cbrt, cbrtf—cube root) contained within standard libraries (also referred to herein as pre-existing functions), such as C/C++ libraries (e.g., Redhat newlib), to deliver standardized behavior and save significant time and effort.

External AOFs further enable calling of internally developed functions (including, e.g., C/C++ functions) created to serve a niche purpose, as corporate building blocks for applications, and the like (also referred to herein as user-defined functions or user-defined AOFs). Since AOFs are resource wide assets and may not retain state across calls, AOFs can be invoked from within any user program organization unit (“POU”), such as, e.g., add-on instructions, subroutines, other AOFs, and the like. Additionally, an end-user can develop an AOF and generate an external AOF by compiling the AOF and installing (or providing) the compiled AOF within a library, which can be saved and downloaded with a variety of applications. Accordingly, an end-user or developer (e.g., an industrial device developer) may generate libraries of external AOFs for use by other users (e.g., via a subscription-based service). External AOFs may be generated from AOFs similar to how composite instructions are generated (as described in greater detail herein). Finally, AOFs may be used to override external AOFs should the latter prove to be anomalous.

Moreover, as noted herein, the technology disclosed herein may also facilitate the generation of AOFs, including, e.g., user-defined functions. For instance, in some configurations, a user may interact (via, e.g., the user device 310) with the application 460 to generate a custom function (e.g., a function generated to serve a niche purpose), as a user-defined function or user-defined AOF, where the user-defined function may be called (or otherwise invoked) as part of executing a user program (or a routine thereof) with the industrial device 305. For instance, a user may generate (or otherwise provide) a routine for execution by the industrial device 305 (e.g., as part of a user program or control application of the industrial device 305). The routine may utilize one or more AOFs, including, e.g., one or more pre-existing AOFs (e.g., a square root function), user-defined functions, or a combination thereof.

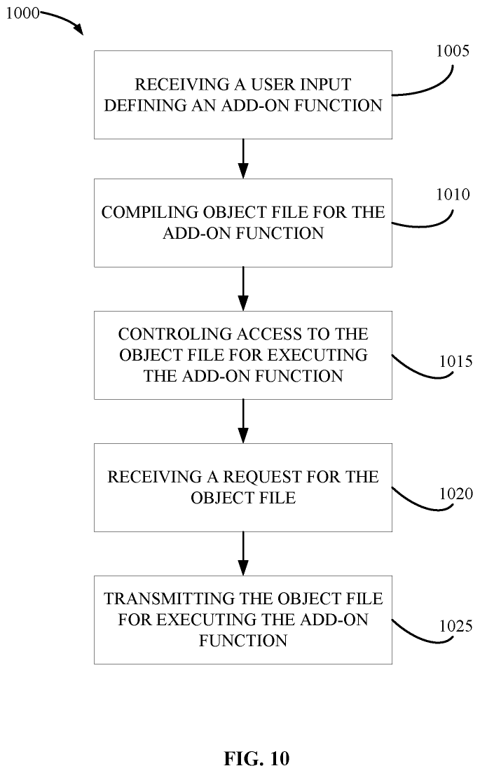

FIG. 10 is a flowchart illustrating an example method 1000 for generating AOFs for implementation with an industrial device (e.g., the industrial device 305) according to some embodiments. The method 1000 is described herein as being performed by the user device 310, and, in particular, the user device electronic processor 400 executing instructions stored in the memory 405 (e.g., the programming application 460).

As illustrated in FIG. 10, the method 1000 may include receiving, with the user device electronic processor 400, a user input defining an AOF (at block 1005). The AOF may be a user-defined function or a pre-existing function. In some configurations, the user input can include a function name (e.g., the function name 615 of FIG. 6), a parameter (e.g., the parameter 620 of FIG. 6), a return type (e.g., the return type 625 of FIG. 6), another parameter for the AOF, or a combination thereof. In some examples, the user input may be received using a user interface, such as, e.g., the user interface 610 of FIG. 6 via the HMI 415 of FIG. 4. For instance, the user interface 610 may be a graphical user interface (“GUI”) that includes one or more command components (e.g., text fields, drop-down menus, radio buttons, etc.). A user may interact with the GUI by providing (via, e.g., the command components) the function name(s), the parameter(s), the return type(s), another parameter for the AOF, or a combination thereof.

The AOF may supplement an instruction set (e.g., a set of instructions included in a routine or user program). For instance, in some configurations the AOF may be configured to perform an OR operation on multiple inputs (e.g., two or more inputs). For example, the AOF may support performance of an OR operation on 8 or 16 inputs. In some configurations, the AOF may perform a data type conversion (e.g., may convert data from a first data type to another data type). As one example, the AOF may convert a numeric data type to a string data type. Example instructions for a data type conversion and a magnitude to string conversion are provided below, respectively:
intX:=REAL_TO_INT(myReal);
Message:=“Order completed at”+TO_STRING(currentTime);

In some configurations, a user input may specify a trigger AOF for triggering execution of an event task. Upon an expression's true evaluation, an event task may be performed for the industrial system 300. In some examples, the AOF may stop or resume the execute of a task associated with a user program of the industrial system 300. In some configurations, the trigger event can be a specified condition met by a variable defined by the user. When the variable satisfies the specified condition, the AOF may be triggered.

In some examples, the AOF can be configured to measure a performance metric associated with a routine of a user program of the industrial system 300. In some instances, the AOF may be hidden from a user. The AOF may be utilized by an integrated development environment (IDE) to, e.g., help a user become more productive. Each of these calls can manage how the code is executed. The use of the IDE can provide the user with an interface to view the context of the operation. In some examples, the AOF may measure performance by wrapping the start calls and end calls around items, where such calls may include, e.g., instructions, routines, AOIs, AOFs, etc. For example, in some configurations, the AOF may identify an error associated with a user program of the industrial device 305. As such, in some instances, the AOF may provide debugging or error monitoring functionality with respect to the user program (or routine thereof). For instance, with respect to debugging, an AOF may be used to, e.g., “break,” “continue,” “singleStep,” “jumpInto,” “jumpOut of code areas. Each of these calls may manage how the code executes. In such configurations, the IDE may provide an interface to view context of the operation.

The user device electronic processor 400 may compile an object file for the AOF (at block 1010). In particular, the object file can be compiled by the user device electronic processor 400 based on the user input (e.g., received at block 1005). In some configurations, the object file may be the object file 830 of FIG. 8 and may contain compiled information relating to the routine 805 provided by the user.

The user device electronic processor 400 may control access to (or transmission of) the object file for executing the AOF (at block 1015). In some configurations, the user device electronic processor 400 can control access to (and transmission of) the object file based on an access model. The access model may be a license model, subscription model, or another type of access control model. A license model may enable access to the object file for executing the AOF a single time (e.g., for a one-time access and use). For example, pursuant to the license model associated with a user, the user may be granted single access to the object file upon payment of a one-time fee. A subscription model may enable access to the object file for executing the AOF multiple times (e.g., for recurring access and use). For example, pursuant to the subscription model associated with a user, the user may be granted continued access to the object file upon payment of a fee for each access.

The user device electronic processor 400 may receive a request for the object file (at block 1020). The user device electronic processor 400 may receive the request from the industrial device 305 (e.g., the industrial device electronic processor 500). For example, in some configurations, the industrial device 305 may generate and transmit the request to the user device electronic processor 400, such as, e.g., as part of executing a user program that utilizes the object file (e.g., the request is generated and transmitted during execution of the user program). Alternatively, or in addition, in some configurations, the industrial device 305 may request the object file after a user program that utilizes the object file is downloaded to the industrial device 305 but prior to execution of that user program. Alternatively, or in addition, in some configurations, the user device electronic processor 400 may not receive a request for the object file. Rather, in such configurations, the user device electronic processor 400 may enable access to or transmission of the object file as part of downloading a corresponding user program to the industrial device 305. For instance, the object file may be included as part of a data packet or the user program downloaded to the industrial device 305.

The user device electronic processor 400 may transmit the object file for executing the AOF (at block 1025). In some configurations, the user device electronic processor 400 may transmit the object file to the industrial device 305. In some examples, other information can be transmitted to the industrial device 305, along with the object file, such as, e.g., the user routine, one or more standard or pre-existing libraries, etc. In one example, an object file may be transmitted as part of a user program and transmission may occur when the user program is downloaded to the industrial device 305, as noted herein. For example, in some instances, the user device electronic processor 400 may transmit the object file without receiving a request to hide the AOF from the user (e.g., such that the user is unaware of the AOF or that the AOF is not viewable or exposed to the user). Accordingly, in some configurations, the user device electronic processor 400 may automatically transmit the object file to the industrial device 305.

In some configurations, the industrial device 305 may receive the object file for executing the AOF. Responsive to receiving the object file, the industrial device 305 may store the object file in a memory of the industrial device 305 (e.g., the industrial device memory 505, the function library 530, etc.). Accordingly, in some instances, the object file may be stored locally by the industrial device 305. The industrial device 305 may execute object code included in the object file to perform the add-on function. Accordingly, in some configurations, the industrial device 305 may perform one or more process steps of the method 700 with respect to the object file for executing the AOF (e.g., as described with respect to the method 1000).

In some configurations, the user device electronic processor 400 may store the object file for the AOF in a function library (e.g., the function library 530) or another database. Accordingly, in some configurations, the object file may be accessed by or transmitted to the industrial device 305 from the function library 530 (or another remote database or storage location).

In some configurations, a user may interact with the user interface 610 to categorize or otherwise group AOFs. AOFs may be grouped based on application type, domain type, category, etc. As one example, a first set of AOFs may related to a first domain and a second set of AOFs may be related to a second different domain. In this example, the first set of AOFs may be compartmentalized into a first AOF group for the first domain and the second set of AOFs may be compartmentalized into a second AOF group for the second domain. As another example, a set of AOFs may provide general math functionality (e.g., perform a mathematical operation or function). In this example, the set of AOFs may be compartmentalized into an AOF group for general mathematical functionality. Accordingly, in some configurations, a user may organize the AOFs.

In some configurations, the user may organize the AOFs via interaction with the user interface 610 (e.g., the application 460). For instance, a user may organize the AOFs by augmenting a function name, a signature, or the like with a namespace prefix. For example, when the function name of the AOF is “myExternalFunction” and the namespace prefix is “Namespace,” a user may augment the function name with the namespace prefix to compartmentalize offerings as follows: Namespace::myExternalFunction( ) Augmenting the function name (or signature) with a namespace prefix enables organization of AOFs while maintaining the AOFs within a single library (e.g., with the database 315, the function library 530, etc.). Alternatively, or in addition, a user may compartmentalize AOFs by implementing multiple libraries, where each library stores related AOFs or AOF groupings.

Accordingly, in some configurations, the user device electronic processor 400 may determine a domain of the AOF. In some examples, the user device electronic processor 400 may determine the domain of the AOF based on user input provided via the user interface 610. Accordingly, in some configurations, the user input (e.g., received at block 1005) may include an indication of a corresponding domain for the AOF. The user device electronic processor 400 may then store, based on the domain, the object file in a function library specific to the domain. Alternatively, or in addition, the user device electronic processor 400 may determine, for the AOF, a namespace prefix specific to a domain relevant to the AOF according to the user input (e.g., received at block 1005) and augment a function name using the namespace prefix.

In some configuration, the systems and methods (or portions or steps thereof) as described herein may be utilized by multiple industrial systems (e.g., the industrial system 300), industrial devices (e.g., the industrial device 305), or a combination thereof. For example, in some instances, the user device electronic processor 400 may receive a plurality of requests for the object file (e.g., as similarly described herein with respect to block 1020). For example, the user device electronic processor 400 may receive a first request from a first industrial device and a second request form a second industrial device. The first and second industrial devices may be included in the same industrial system or different industrial systems (e.g., a first industrial system, a second industrial system, etc.). Responsive to receiving the plurality of requests, the user device electronic processor 400 may transmit the object file for executing the AOF to one or more of the industrial devices or systems (e.g., as similarly described herein with respect to block 1025).

What has been described above includes examples of the disclosed technology. It is, of course, not possible to describe every conceivable combination of components or methodologies for purposes of describing the disclosed technology, but one of ordinary skill in the art may recognize that many further combinations and permutations of the disclosed technology are possible. Accordingly, the disclosed technology is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the disclosed technology. In this regard, it will also be recognized that the invention includes a system as well as a computer-readable medium having computer-executable instructions for performing the acts and/or events of the various methods of the invention.

In addition, while a particular feature of the disclosed technology may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

What is claimed is:

1. A system for facilitating add-on functions for industrial devices, the system comprising:
one or more electronic processors configured to:
receive, via a user interface, a user input defining an add-on function, wherein the user input includes a function name for the add-on function;
compile, based on the user input, an object file for the add-on function;
control access to the object file for executing the add-on function;
receive, from an industrial device of an industrial system, a request for the object file; and
transmit, to the industrial device of the industrial system, the object file for executing the add-on function.

2. The system of claim 1, wherein the user input further includes at least one of a parameter or a return type for the add-on function.

3. The system of claim 1, wherein the system further comprises:
the industrial device, the industrial device is configured to:
store the object file in a memory of the industrial device; and
execute object code included in the object file to perform the add-on function.

4. The system of claim 3, wherein execution of the object code included in the object file generates an output of the add-on function, wherein the industrial device is configured to utilize the output of the add-on function as an operand for a subsequent operation.

5. The system of claim 3, wherein the system further comprises:
a second industrial device of a second industrial system, the second industrial system different from the industrial system, and
wherein the one or more electronic processors are configured to:
receive, from the second industrial device of the second industrial system, a second request for the object file; and
transmit, to the second industrial device of the second industrial system, the object file for executing the add-on function.

6. The system of claim 1, wherein the add-on function is configured to perform an OR operation on at least three inputs.

7. The system of claim 1, wherein the add-on function is configured to perform a data type conversion, wherein the data type conversion includes converting a numeric data type to a string data type.

8. The system of claim 1, wherein the one or more electronic processors are configured to:
store, in a database, the object file for the add-on function in a function library; and
responsive to receiving the request for the object file,
access, from the database, the object file for the add-on function from the function library; and
transmit the object file to the industrial device.

9. The system of claim 1, wherein the one or more electronic processors are configured to:
determine a domain of the add-on function; and
store, based on the domain, the object file in a function library specific to the domain.

10. The system of claim 1, wherein the one or more electronic processors are configured to:
determine, for the add-on function, a namespace prefix specific to a domain relevant to the add-on function; and
augment a function name of the add-on function with the namespace prefix.

11. The system of claim 1, wherein execution of the add-on function using an expression as an input that triggers an event in the industrial system.

12. The system of claim 11, wherein the add-on function stops or resumes execution of at least one task associated with a user program of the industrial system.

13. The system of claim 1, wherein the add-on function is a user-defined function.

14. The system of claim 1, wherein the add-on function is configured to measure a performance metric associated with a routine associated with a user program of the industrial system.

15. The system of claim 14, wherein the one or more electronic processors are configured to generate an annotated call graph based on the performance metric.

16. A method for facilitating add-on functions for industrial devices, the method comprising:
receiving, with one or more electronic processors, user input defining a plurality of add-on functions, wherein the user input includes, for each add-on function of the plurality of add-on functions, at least one of a function name, a parameter, or a return type;
compiling, with the one or more electronic processors, an object file for each add-on function of the plurality of add-on functions as a set of object files;
storing, with the one or more electronic processors, the set of object files in one or more function libraries;
receiving, with the one or more electronic processors, from a first industrial device, a request for a first object file included in the set of object files, wherein the first object file includes object code for performing a first add-on function of the plurality of add-on functions; and
transmitting, with the one or more electronic processors, to the first industrial device, the first object file including object code that, when executed, performs the first add-on function.

17. The method of claim 16, further comprising:
transmitting, to a second industrial device, the first object file including object code that, when executed, performs the first add-on function.

18. The method of claim 17, further comprising:
transmitting, to the first industrial device, a second object file included in the set of object files, wherein the second object file includes object code for performing a second add-on function of the plurality of add-on functions, wherein the second add-on function is configured to identify an error associated with a user program of the first industrial device.

19. The method of claim 16, further comprising:
transmitting, to the first industrial device, a second object file including object code that, when executed, performs a second add-on function of the plurality of add-on functions, wherein the first add-on function is a user defined function and the second add-on function is a pre-existing function.

20. The method of claim 16, further comprising:
controlling, with the one or more electronic processors, access to the set of object files pursuant to a license model.
